(19) United States
(12) Patent Application Publication
(10) Pub. No.: US 2004/0085765 A1
(43) Pub. Date: May 6, 2004

(54) Illuminated twinkling decorative display device

(76) Inventors: Terry Hermanson, New York, NY (US); Huang Meng-Suen, Kowloon (HK)

Correspondence Address: FITZPATRICK CELLA HARPER & SCINTO, 30 ROCKEFELLER PLAZA, NEW YORK, NY, 10112, US

(21) Appl. No.: 10/287,622

(22) Filed: Nov. 5, 2002

(51) Int. Cl. F21V 21/00

(52) U.S. Cl. 362/249; 362/806; 362/808

(57) ABSTRACT

A decorative display device includes a number of focused light sources that are arranged and manipulated to provide a twinkling effect. That effect is created by the light sources so that different ones of them are directed toward an observer at different times.

### BACKGROUND OF THE INVENTION

1. Field of the Invention

The present invention relates to a decorative display device, and more particularly to an illuminated twinkling decorative display device.

2. Discussion of Related Art

Decorative display devices, coupled with decorative lights, are an important element of any holiday season, especially Christmas. Decorative lighting during the Christmas season includes Christmas tree lights, exterior lights on buildings, trees and foliage, and interior lights displayed in windows, and throughout homes or buildings.

A twinkling effect is a desirable characteristic of decorative lights. A twinkling effect may be achieved by flashing individual or multiple lights on and off in a regular or random pattern, mixing colors, and mixing light intensities. U.S. Pat. No. 6,424,096, for example, discloses a remote control system for generating such a twinkling effect with a plurality of light strings. U.S. Pat. No. 5,256,948 discloses an electronic cycling switch for a series string of light-emitting diodes (LED's) that causes the LED's to flash and twinkle in various patterns.

Hence, it is desirable to continue to introduce new and innovative ways to create pleasing effects for display and illumination of decorative elements, including twinkling effects, and the present invention further addresses this need.

### SUMMARY OF THE INVENTION

The present invention provides for a decorative display device, for example, outlined in twinkling lights. The twinkling effect is created by a plurality of focused light sources that are canted in different directions, and by moving the lighted decorative display device in a manner which passes the figure before the eyes of an observer.

In accordance with one aspect, the present invention is directed to a decorative display device comprising a decorative figure, a background support for or in the form of the figure mounted on a base, and a plurality of focused light sources mounted on the support in such a way that adjacent or nearly adjacent focused light sources are canted or angled in different directions. The decorative display device further comprises means incorporated in the base for moving the support so that different ones of the light sources are focused toward an observer at different times. In this way, a twinkling effect is achieved. The decorative device may further comprise a power source, mounted on the base, and connected to both the light sources, and to the means for moving the support.

In accordance with another aspect, the present invention is directed to a decorative display device comprising a decorative figure that is in the form of an outline or border of the shape of the figure, a background support for the decorative figure mounted on a base, and a plurality of focused light sources mounted on the support in such a way that adjacent or nearly adjacent focused light sources are canted in different directions. The decorative device further comprises means for moving the support, again so that different ones of the light sources are focused toward an observer at different times. The decorative device can still further comprise a power source, mounted on the base, and connected to both the focused light sources, and to the means for moving the support.

In accordance with another aspect, the present invention is directed to a decorative display device such as that briefly described above wherein the focused light sources are mounted on the support so as to be canted or angled in random directions.

In accordance with yet another aspect, the present invention is directed to a decorative display device such as that briefly described above wherein the focused light sources are mounted on the support so as to be canted or angled in repeating patterns of directions.

In accordance with still another aspect, the present invention is directed to a decorative display device in which the means for moving the support causes oscillatory motion.

In accordance with these aspects, the decorative display device may incorporate the decorative figure mounted on the background support with the light sources arranged to form an outline or border that appears to twinkle when the support is moved.

An advantage of the present invention is the desired twinkling effect may be achieved without complex cycling switches or complicated wiring harnesses. The motion of the decorative display device is also aesthetically pleasing to an observer. The present invention may also be adapted to a variety of decorative configurations and symbols.

### BRIEF DESCRIPTION OF THE DRAWINGS

The foregoing and other aspects of the present invention will best be appreciated with reference to the detailed description of the invention in conjunction with the accompanying drawings, wherein:

FIG. 1 is a front perspective view of an illuminated twinkling decorative display device, in accordance with an exemplary embodiment of the present invention, wherein the decorative display device is in the form of a candle,

FIG. 2 is a front perspective view of an illuminated twinkling decorative display device, in accordance with an exemplary embodiment of the present invention, wherein the decorative display device is in the form of an outline of a candle.

FIG. 3 is a perspective rear view of a means for moving the illuminated twinkling decorative figure, in accordance with an exemplary embodiment of the present invention.

FIGS. 4A, 4B and 4C are horizontal, cross-sectional views taken respectively on planes 4A-4A, 4B-4B and 4C-4C in FIG. 1, showing how different light sources are oriented differently in accordance with the present invention.

FIGS. 5 to 8 are perspective views of four illuminated twinkling decorative display devices, in accordance with additional exemplary embodiments of the present invention.

### DETAILED DESCRIPTION OF PREFERRED EMBODIMENTS

The present invention is directed to a decorative display device outlined in or otherwise having a pattern of twinkling lights. The twinkling effect is created by a plurality of focused light sources that are canted or angled in different directions, and by moving the lighted decorative display device in a manner that causes different light sources to be directed or focused toward the eyes of an observer.

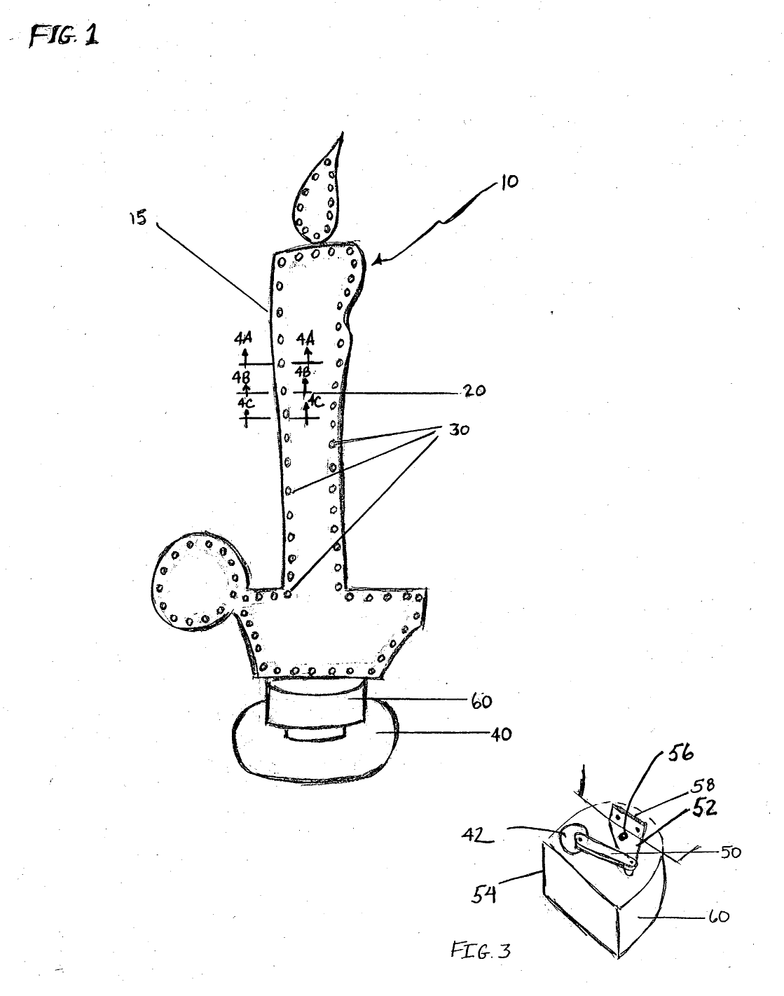

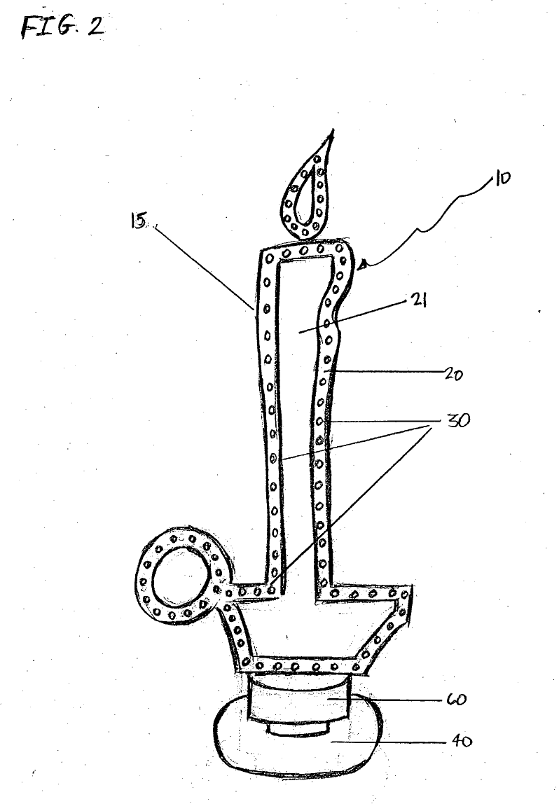

While the present invention may be realized in a number of exemplary embodiments, for ease of explanation, one exemplary embodiment will be described in detail. Referring to the figures wherein like numerals indicate the same element throughout the views, there is shown in FIG. 1 an illuminated twinkling decorative display device 10 comprising a decorative FIG. 15 in the shape of a candle, a background support 20 that defines or on which is mounted the decorative FIG. 15, and a plurality of “focused” light sources 30 mounted on the background support 20. The support 20 may be fully enclosed, or as illustrated in FIG. 2, may simply be an outline of the shape of a decorative figure with an open interior 21. The device also comprises means for moving the support 20 and consequently the associated FIG. 15, which is illustrated in FIGS. 1 and 3. As shown there, this means includes a base 40, and a driving apparatus such as a motor 60 mounted on the base 40, the rotary output 42 of which drives a crank 50. The crank 50 is coupled to a lever 52 that is mounted on the top of the housing 54 for the motor 60 on a shaft 56. Accordingly, when the motor 60 is driven, its output pushes and pulls the crank 50 to in turn cause the lever to oscillate about the shaft. A mounting plate 58 is formed or attached to the lever 52 at a location relative to the shaft 56, opposite the coupling of the crank to the lever. The support 20 is secured to the plate 58, by suitable means like screws, glue or other fasteners, to place the support and the decorative figure in a vertical orientation. (Of course, the principles of the invention are equally applicable where the elements are oriented so that the support and figure are disposed in attitudes other than the vertical, as described above).

Accordingly, when the lever is driven in an oscillatory manner by the motor, the support and figure will similarly move in an oscillatory manner. (The invention is not limited to the use of moving means that drive the support and figure in an oscillatory manner, but encompasses other forms of movement such as rotary motion).

As noted, the light sources 30 are “focused,” by which is meant that light emitted from them tends to appear to be brighter when viewed from a particular angle than from other angles. For example, the light source 30 may appear to be brighter when viewed along the primary axis of the light source structure than when viewed from locations off-axis. An example of such a light source is a light-emitting diode (LED), but other light source types may be used.

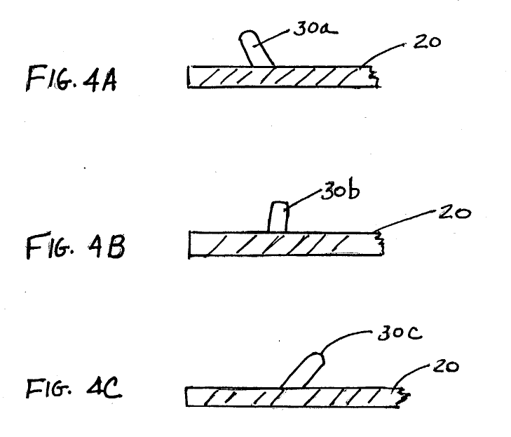

As shown in FIGS. 4A, 4B and 4C, different light sources 30a, 30b and 30c are mounted on the support 20 to be focused in different directions. Accordingly, when the support 20 and light sources 30a, 30b and 30c are oscillated, to the generally stationary observer the light source 30a will first appear to be brightest, while the other sources 30b and 30c will appear to be less bright. Thereafter, the source 30b will appear brightest while the others appear to fade, and then the source 30c will appear brightest. Thus the combined effect of the moving support and differently oriented focused light sources is to cause the light produced by the display to appear to twinkle.

The light sources can be mounted on the support in canted fashion as described above, in any desired pattern. For example, they can be alternately canted to the left, to the center and to the right as shown progressively in FIGS. 4A to 4C. Or, they can be mounted to be canted randomly.

The power for the motor and light sources can be provided by external line current, batteries, solar cells or other known sources.

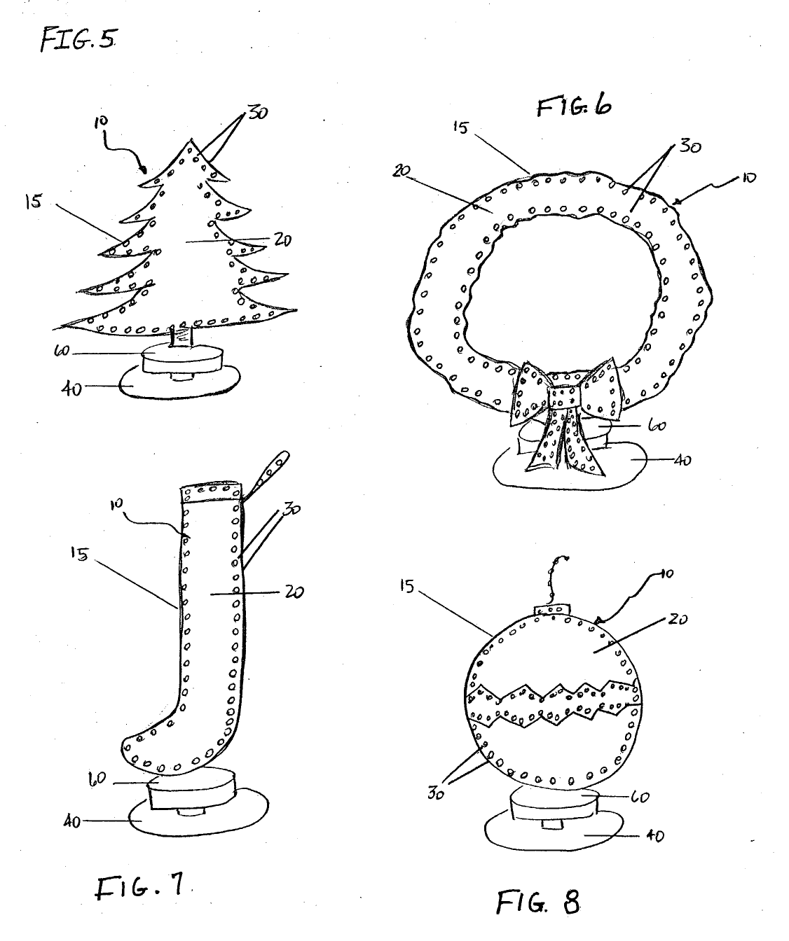

The decorative FIG. 15 may be in any desirable form. As illustrated in FIGS. 5 to 8, the FIG. 15 may be any other Christmas-related decorative display device, including Christmas trees, wreaths, Christmas stockings and Christmas tree ornaments. However, the decorative display device 15 is not limited to Christmas symbols, and may be in the shape of any suitable holiday symbol, or any other symbol (including Menorahs, Halloween pumpkins, birthday cakes, Easter bunnies, etc.), and/or may spell out a written or symbolic message. The background support 20 may be any suitable material and any suitable color, or may preferably be black.

The light sources 30 may also comprise any desirable color or combination of two or more colors, or any suitable light intensity or combination of light intensities.

Accordingly, it will be appreciated that the present invention provides a novel and aesthetically pleasing display device that is characterized by attractive movement and a twinkling light feature.

Although shown and described are what are presently believed to be the preferred embodiments, it is apparent that departures from specific designs and methods described and shown will suggest themselves to those skilled in the art and may be used without departing from the spirit and scope of the invention. The present invention is not restricted to the particular constructions described and illustrated, but should be constructed to encompass all modifications that may fall within the scope of the following claims.

That which is claimed is:

1. A decorative display device comprising:
a support in the form a decorative figure;
a plurality of focused light sources mounted on said support, different ones of said plurality of light sources being mounted on said support to be canted in different directions; and
means for moving said support and said plurality of light sources mounted thereon to cause different ones of said light sources to be focused toward an observer at different times, thereby to provide a twinkling visual effect to the observer.

2. The decorative display device of claim 1, wherein said decorative figure is formed to define a decorative shape.

3. The decorative display device of claim 1, wherein said support is black.

4. The decorative display device of claim 1, wherein said plurality of focused light sources are mounted on said support to be canted in random directions.

5. The decorative display device of claim 1, wherein said plurality of focused light sources are mounted on said support to be canted in repeating patterns of directions.

6. The decorative display device of claim 1, wherein said focused light sources comprise light-emitting diodes.

7. The decorative display device of claim 1, wherein said means for moving said support comprises a motor.

8. The decorative display device of claim 7, further comprising means for coupling said motor to said support to cause said motor to drive said support for oscillatory motion.

9. The decorative display device of claim 1, wherein said means for moving said support causes said support to move with oscillatory motion

10. The decorative display device of claim 1, wherein said means for moving said support causes said support to move with rotary motion.

11. The decorative display device of claim 1, wherein said focused light sources comprise at least two colors.

12. The decorative display device of claim 1, wherein said focused light sources comprise at least two light intensities.

13. For use with a decorative display device, the improvement comprising:
a plurality of focused light sources mounted to be canted in different directions; and
a mechanism for moving said decorative display device to cause different ones of said light source to be focused toward an observer at different times, thereby to provide a twinkling visual effect to the observer.

14. The decorative display device improvement of claim 13, wherein said light sources are mounted to be canted in random directions.

15. The decorative display device improvement of claim 13, wherein said light sources are mounted to be canted in repeating patterns of directions
